(19) United States
(12) Patent Application Publication
(10) Pub. No.: US 2007/0159954 A1
(43) Pub. Date: Jul. 12, 2007

(54) Laser oscillation element and optical pickup device

(75) Inventors: Keiji Sakai, Nara-shi (JP); Renzaburoh Miki, Soraku-gun (JP); Yukio Watanabe, Uji-shi (JP); Osamu Miyazaki, Soraku-gun (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 10/589,739

(22) PCT Filed: Jan. 28, 2005
(86) PCT No.: PCT/JP05/01248

§ 371 Date: Aug. 16, 2006

(30) Foreign Application Priority Data
Feb. 19, 2004 (JP) 2004-043559

(51) Int. Cl. G11B 7/00

(52) U.S. Cl. 369/121; 369/112.05

(57) ABSTRACT

In a light-emitting section (2) for emitting semiconductor laser for CD (4) and semiconductor laser for DVD (5), a radiation angle width θ2 of the DVD semiconductor laser (5) is at least 1.3 times a radiation angle width θ1 of the CD semiconductor laser (4), said radiation angle width being defined as a width of an angle created by two straight lines, which extend respectively from a laser-emitting point to two points where a radiation intensity of laser becomes half of an intensity of the center of laser, which points reside within a plane parallel to a pn junction plane.

### TECHNICAL FIELD

The present invention relates to a laser oscillation element and an optical pickup device both used for an optical disk recording/reproducing apparatus which carries out recording/reproducing of information into/from an information storage medium, such as an optical disk.

### BACKGROUND ART

Some of conventional optical pickup devices are capable of handling two kinds of optical disks. Such an optical pickup device often includes two kinds of light sources: a light source for emitting laser of 655 nm wavelength for recording/reproducing DVD disks, and a light source for emitting laser of 785 nm wavelength for recording/reproducing CD-type disks (see Japanese Unexamined Patent Publication Tokukai 2001-184707 (published on Jul. 6, 2001)).

In this type of optical pickup device, light utilization efficiency and Rim intensity are designed based on a ratio (optical ratio of the numerical aperture of the objective lens to the numerical aperture of the collective lens, and therefore the optical ratio is determined in consideration of the light utilization efficiency and the Rim intensity.

The light utilization efficiency denotes a ratio of light used for recording/reproduction of an optical disk with respect to the gross amount of light emitted from the light source, which is expressed as 1. Meanwhile, the Rim intensity denotes a relative intensity of light at the edge of the pupil to the maximum light intensity at the entrance pupil (for an optical pickup device, corresponding to the numerical aperture of the optical lens), which is expressed as 100%. In a general optical pickup device, a greater Rim intensity makes optical intensity distribution on the optical lens more even, and therefore the laser collected by the objective lens is focused on the optical disk with a smaller spot diameter.

The intensity of the semiconductor laser typically used for an optical pickup device is maximum at the center, and gradually diminishes toward its periphery. This is consistent with the Gaussian light intensity distribution. That is, when the Rim intensity is large, only the light in the center is utilized, and the light utilization efficiency automatically decreases.

Therefore, the optical ratio of the DVD optical system using laser light of 655 nm wavelength and the optical ratio of the CD optical system using laser light of 785 nm wavelength are generally required to be set to the optimal values in consideration of the light utilization efficiency and the Rim intensity.

As described, the optical ratio is a ratio of the numerical aperture of the objective lens to the numerical aperture of the collective lens. Since the numerical aperture of the objective lens is fixed according to the type of optical disk, the optical ratio is varied by changing the numerical aperture of the collective lens.

The numerical aperture (sin θ) of a lens is determined by a formula: sin θ=a/f where “a” expresses the effective diameter of lens and “f” expresses the focal length. In the optical pickup device according to Tokukai 2001-184707, the focal length of the collective lens of the CD optical system differs from that of the collective lens of the DVD optical system. This changes the numerical aperture of the collective lens. In this way, the optical ratio of the DVD optical system and the optical ratio of the CD optical system may be set arbitrarily.

However, the recent severe demands for a thinner and a smaller optical pickup device, and for reduction in cost requires the optical system to be more simply structured. In view of this requirement, there has been suggested a 2-wavelengths laser capable of oscillating two kinds of wavelengths for DVD and for CD. Particularly, many of the reproduction-only models now use the 2-wavelengths laser. Japanese Unexamined Patent Publication Tokukai 2003-263773/2003 (published on Sep. 19, 2003) discloses an optical pickup device using a 2-wavelengths laser in which two collective lenses are provided in the CD optical system and the DVD optical system. This structure allows the respective focal lengths of the collective lens of the CD system and the collective lens of the DVD system to be varied separately. In this way, the optical ratio of the DVD optical system and the optical ratio of the CD optical system may be set arbitrarily.

### DISCLOSURE OF INVENTION

However, the optical pickup device using a 2-wavelengths laser in which two collective lenses are provided in the CD optical system and the DVD optical system has a problem of increase in component number and increase in size of device body.

Therefore, to meet the demands for a thinner and a smaller optical pickup device, and reduction in cost, a single lens serving both as the objective lens and the collective lens needs to be provided in the CD optical system and in the DVD optical system. In this case, the two wavelengths are emitted from substantially the same point, and the optical system including the objective lens and the collective lens are also unified. Therefore the optical ratios in the CD optical system and the DVD optical system become substantially equal.

The reproduction-only optical pickup device including a laser oscillation device capable of oscillating 2-wavelength lasers requires less optical ratio in scanning the optical disk than an optical pickup device capable of information recording. Therefore, output of laser light is sufficient, and the light utilization efficiency does not need to be taken into account. Since the Rim intensity of reproduction-only optical pickup device can be increased by increasing the focal length of the collective lens, the light-condensing spot on the optical disk can be decreased sufficiently.

In contrast, the optical pickup device capable of information recording needs to carry out recording at a possible highest speed with a limited amount of laser output, and therefore utilization efficiency of laser light must be high. Therefore, contrary to the reproduction-only optical pickup device, the light utilization efficiency can be increased by decreasing the focal length of the collective lens. On the other hand, the Rim intensity decreases and the diameter of the light-condensing spot on the optical disk increases.

However, a DVD has a higher recording density than a CD, and the light spot is required to be well-condensed to ensure desirable quality of reproduction signal. In other words, the Rim intensity needs to be high. However, this requirement cannot be met with the short focal length of the collective lens.

The present invention is made in view of the foregoing conventional problems, and an object is to provide a laser oscillation element and an optical pickup device for realizing high-speed recording of CD and high-quality reproduction of DVD.

A laser oscillation element according to the present invention emits first semiconductor laser and second semiconductor laser shorter in wavelength than the first semiconductor laser, a radiation angle width of the second semiconductor laser being at least 1.3 times a radiation angle width of the first semiconductor laser, said radiation angle width being defined as a width of an angle created by two straight lines, which extend respectively from a laser-emitting point to two points where a radiation intensity of laser becomes half of an intensity of the center of laser, which points reside on the line of intersection between a plane parallel to a light-emitting plane of the first or the second semiconductor laser and a plane parallel to a pn junction plane.

With this structure, the second semiconductor laser is shorter in wavelength than the first semiconductor laser. This arrangement allows the oscillation element to be used for an optical pickup device capable of reproduction of CD and DVD. In this case DVD reproduction is carried out by the second semiconductor laser and CD recording/reproduction is carried out by the first semiconductor laser.

However, in such an optical pickup device performing CD/DVD information recording with a laser oscillation element capable of emitting two types of laser beam of different wavelengths, the Rim intensity of the objective lens may not be sufficient to realize high-speed recording of CD or high-quality reproduction of DVD depending on the focal length with the collective lens.

In view of this problem, the inventors of the present invention have carried out an intensive study, and found that the Rim intensity of CD objective lens and the Rim intensity of DVD objective lens can be defined by a ratio (radiation angle ratio, hereinafter) of the radiation angle width of the second semiconductor laser to the radiation angle width of the first semiconductor laser. The inventors further confirmed with an experiment that the radiation angle ratio of at least 1.3 ensures a Rim intensity enabling high-speed CD recording and high-quality DVD reproduction at the same time.

The radiation angle ratio is set to at least 1.3 in the laser oscillation element of the present invention; therefore, by being mounted to an optical pickup device, the laser oscillation element of the present invention realizes high-speed CD recording and high-quality DVD reproduction at the same time.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a drawing showing a structure of a laser oscillation device according to one embodiment of the present invention.

FIG. 2 is a perspective view showing a relationship between the pn junction plane of a light-emitting section in the laser oscillation device of FIG. 1 and the direction of laser radiation.

FIG. 3 is a drawing showing a structure of an optical pickup device including the laser oscillation device of FIG. 1.

FIG. 4 is a graph showing a relationship between the radiation angle width and the radiation intensity.

FIG. 5 is a drawing showing another structure of the optical pickup device including the laser oscillation device of FIG. 1.

FIG. 6 is a drawing showing still another structure of the optical pickup device including the laser oscillation device of FIG. 1.

FIG. 7 is a drawing showing a relationship between a coupling efficiency and a radiation angle θ∥ of DVD.

FIG. 8 is a drawing showing a relationship between a coupling efficiency and a radiation angle ratio of DVD.

### BEST MODE FOR CARRYING OUT THE INVENTION

[1. Structure of Laser Oscillation Device]

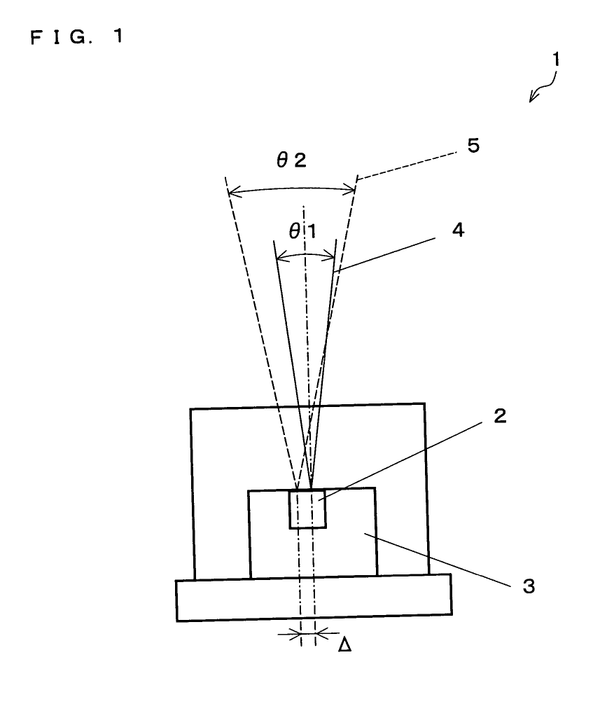

One embodiment of the present invention is described below with reference to Figures. As shown in FIG. 1, a laser oscillation device 1 according to the present embodiment includes a stem 3 and a light-emitting section (laser oscillation element) capable of oscillating laser rays of two different wavelengths. The light-emitting section is provided on the stem 3. The light-emitting points of these two wavelength have an interval denoted by Δ. From the light-emitting section 2, a long wavelength laser ray (first semiconductor laser) 4 and a short wavelength laser ray (second semiconductor laser) 5 are oscillated.

A “radiation angle width” is defined as a width of an angle created by two straight lines, which extend respectively from two points where the radiation intensity of laser becomes half of the intensity of the center of laser, which points reside on the line of intersection between a plane parallel to the light-emitting plane of the semiconductor laser and a plane parallel to the pn junction plane; in other words, a full width at half maximum. The radiation angle width of the ray 4 is expressed as θ1 and the radiation angle width of the ray 5 is expressed as θ2.

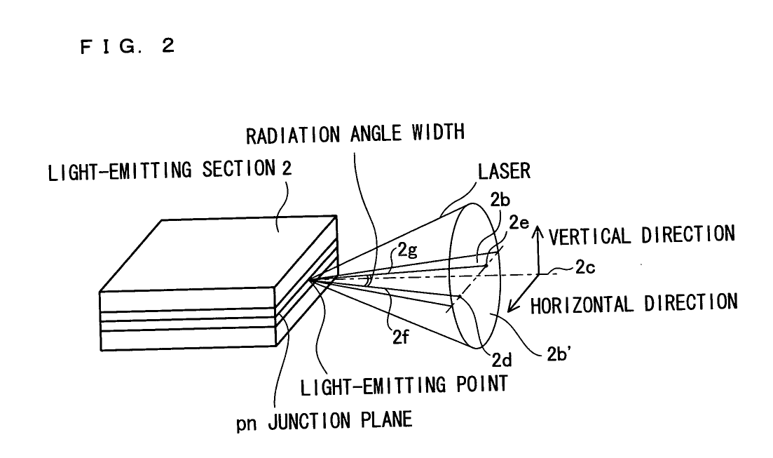

With reference to FIG. 2, the following explains a relationship between the pn junction plane of the semiconductor and laser light in the light-emitting section 2. As shown in FIG. 2, the light-emitting section 2 emits laser from the pn junction plane of the semiconductor contained therein. Therefore, the laser diffuses into the perpendicular direction and the parallel direction with respect to the pn junction plane.

In the case where the laser is emitted as shown in FIG. 2, a plane extending from the light-emitting point 2a in parallel to the pn junction plane is expressed as a plane 2b, and a plane parallel to the light-emitting plane of the semiconductor laser is expressed as a plane 2b′. Then, the light-emitting point 2a is connected respectively to the two points 2d and 2e where the radiation intensity of laser becomes half of the intensity of the central axis 2c of laser, which points reside on the line of intersection between the plane 2b and the plane 2b′. The angle created by these straight lines 2f and 2g connecting 2a and 2b/2b is the “radiation angle width”.

In a general semiconductor laser oscillation device, because of its property, a radiation angle θ⊥ perpendicular to the pn junction plane is larger than the radiation angle θ∥ in parallel to the pn junction plane. More specifically, the radiation angle θ⊥ is 1.5 to 3 times the radiation angle θ∥. Note that, in the description below, “perpendicular direction” denotes a direction perpendicular to the pn junction plane of the semiconductor laser oscillation device. On the other hand, “parallel direction” denotes a direction parallel to the pn junction plane.

Therefore, the Rim intensity in the perpendicular direction with respect to the pn junction plane is greater than that in the parallel direction. On this account, the laser in the perpendicular direction can be well-condensed in contrast to the laser in the parallel direction. Therefore, only the radiation angle in the parallel direction is taken into account in the description below.

However, the following factors need to be taken into account. Because a DVD has a higher recording density than a CD, the light spot is required to be well-condensed to ensure desirable quality of reproduction signal. Therefore, in the semiconductor laser oscillation device, the Rim intensity of the objective lens in the parallel direction with respect to the pn junction plane is preferably increased as much as possible. However, because of the difference in numerical aperture of the objective lens, the Rim intensities of the optical pickup device for DVD and of the optical pickup device for CD vary even when the radiation angles are identical. This factor needs to be taken into account in determining the radiation angles.

Specifically, the radiation angle is determined according to the following (i) through (iv).

(i) The numerical aperture of the objective lens for CD is generally 0.5. The laser condensing angle of the aperture is therefore found as: sin⁻¹ 0.5=30°

(ii) The numerical aperture of the objective lens for DVD is generally 0.6 or 0.63. The laser condensing angle of the aperture is therefore found as: sin⁻¹ 0.60=36.87°, or sin⁻¹ 0.63=39.05°

(iii) The ratio (optical ratio) of the numerical aperture of the objective lens to the numerical aperture of the collective lens is 1 or more. Further, in the semiconductor laser device capable of oscillating two lasers of different wavelengths, the two laser rays are emitted from a single light source. Therefore the DVD system and the CD system have the same optical ratio.

(iv) The ratio of the Rim intensity is determined by the ratio of the radiation angle of the DVD semiconductor laser to the radiation angle of the CD system.

The foregoing (i) through (iv) teach that setting the radiation angle of the DVD semiconductor laser to a value at least 1.3 (39.05/30=1.3) times the radiation angle of the CD semiconductor laser ensures setting of the Rim intensity of the DVD system in the parallel direction with respect to the pn junction plane to a value greater than that of the CD system in the parallel direction with respect to the pn junction plane. By thus increasing the Rim intensity, the light spot on a DVD can be sufficiently condensed.

More specifically, because the radiation angle of the DVD semiconductor laser is set at least 1.3 times the radiation angle of the CD semiconductor laser, it is possible to set the focal length of the collective lens to a value sufficient to ensure the required light utilization efficiency for carrying out recording of a CD, and also condense the laser light spot to a degree sufficient for DVD reproduction. Note that, the lower limit of the ratio (hereinafter referred to as “radiation angle ratio” as appropriate) of the radiation angle of the DVD semiconductor laser to the radiation angle of the CD semiconductor laser is determined to an appropriate value with which the Rim intensity required for recording/reproducing DVD is obtained.

Further, if recording to DVD is more important in the laser oscillation device capable of oscillating two lasers of different wavelengths, the light-condensing spot on a DVD disk needs to be further reduced. Some of the objective lens for DVD recording has an NA of 0.65.

In this case, the focusing angle of DVD laser is expressed as: sin⁻¹ 0.65=40.05°. Accordingly, setting the radiation angle of the DVD semiconductor laser to a value at least 1.35 (40.05/30) times the radiation angle of the CD semiconductor laser ensures a larger Rim intensity of the DVD system in the parallel direction than that of the CD system in the parallel direction. Note that, also in this case of setting the radiation angle ratio to 1.35 or greater, the lower limit of the radiation angle ratio is determined to an appropriate value with which the Rim intensity required for recording/reproducing DVD is obtained.

[1-1. Experiment with No Consideration of DVD Recording]

The following describes more concrete experiment regarding the relationship between the radiation angle and the CD high-speed recording, conducted by the inventors.

This experiment used an objective lens 3 mm in focal length and 0.6 in numerical aperture (NA). In other words, the objective lens in the DVD system in this experiment was only capable of DVD reproduction and does not ensure a DVD-recording function.

In this experiment, the objective lens was a compatible lens also capable of CD recording/reproduction. As an objective lens for CD, it is 3 mm in focal length and 0.5 in numerical aperture. The collective lens in this experiment was 18 mm in focal length. The entire transmittance of the optical system, which is constituted typically of a collective lens, objective lens, beam splitter wavelength plate was set to 0.6.

For the short wavelength laser for DVD, the radiation angle θ∥ in the parallel direction was set to 10°, and the radiation angle θ⊥ in the perpendicular direction was set to 30°. For the long wavelength laser for CD, the radiation angle θ⊥ in the perpendicular direction was set to 16°, and the radiation intensity was set to 180 mW.

Under such a condition, the radiation angle θ∥ of the long wavelength laser for CD was varied, and the coupling efficiency and the Rim intensity of the CD optical system were measured for each case, so as to check the possibility of CD recording at a speed of 48-times faster. The result is shown in Table 1 below. Note that, the coupling efficiency denotes light utilization efficiency of laser light determined by optical conditions such as the optical lens or the radiation angle of laser.

Note that, if assume that recording at a given speed requires light of 6 mW, the light intensity required for recording at a speed of 48-times faster is calculated as 6×√48=41.5 mW. Accordingly, in Table 1, “∘” denotes an OL emission intensity of 41.5 mW or greater, which indicates capability of recording at a speed of 48-times faster. Note that, the OL emission intensity denotes an intensity of laser emitted from the objective lens.

TABLE 1

θ || of CD laser

| | 7.4° | 7.7° | 8.0° | 8.4° |
|---|---|---|---|---|
| Radiation | 1.35 | 1.3 | 1.25 | 1.2 |
| angle ratio | | | | |
| Coupling | 0.393 | 0.384 | 0.376 | 0.364 |
| efficiency | | | | |
| Rim intensity | 0.315 | 0.344 | 0.372 | 0.408 |
| OL emission | 56.7 | 41.5 | 40.7 | 39.2 |
| intensity | | | | |
| (mW) | | | | |
| Judgment | ∘ | ∘ | Δ | x |

The table has shown that the radiation angle ratio is preferably set to at least 1.3 to perform high-speed recording of CD.

[1-2. Experiment with Consideration of DVD Recording]

When the θ∥ of CD laser is set to 7.7° in the foregoing experiment, the Rim intensity of DVD becomes 0.402. Therefore, if the Rim intensity becomes approximately 0.4 in a DVD objective lens 0.63 to 0.65 in NA, which is capable of DVD recording, it becomes possible to realize a laser oscillation device capable of recording/reproduction of DVD.

The inventors of the present invention also carried out an experiment regarding the Rim intensity and the radiation angle ratio for a DVD objective lens for a DVD objective lens 0.63 in NA and for a DVD objective lens for a DVD objective lens 0.65 in NA. The following explains the result.

In this experiment, the objective lens was a compatible lens which serves as a DVD objective lens 3 mm in focal length, and also serves as a CD objective lens 3 mm in focal length and 0.5 in NA. The collective lens in this experiment was 18 mm in focal length. The entire transmittance of the optical system, which is constituted typically of a collective lens, objective lens, beam splitter wavelength plate was set to 0.6.

For the short wavelength laser for DVD, the radiation angle θ⊥ in the perpendicular direction was set to 20°, and the radiation intensity was set to 100 mW. For the long wavelength laser for CD, the radiation angle θ⊥ in the perpendicular direction was set to 16°, the radiation angle θ∥ in the parallel direction was set to 7.7°, and the radiation intensity was set to 180 mW.

The relationship between the radiation angle ratio and the Rim intensity is shown in Table 2 below for the DVD objective lens 0.63 in NA.

TABLE 2

| | Radiation | | |
|---|---|---|---|
| | angle θ \|\| | | |
| | of DVD | | |
| | 10 | 10.4 | 10.8 |
| Radiation | 1.3 | 1.35 | 1.4 |
| angle ratio | | | |
| Rim intensity | 0.366 | 0.394 | 0.422 |

The relationship between the radiation angle ratio and the Rim intensity is shown in Table 2 below for the DVD objective lens 0.65 in NA.

TABLE 3

| | Radiation | | |
|---|---|---|---|
| | angle θ \|\| | | |
| | of DVD | | |
| | 10 | 10.4 | 10.8 |
| Radiation | 1.3 | 1.35 | 1.4 |
| angle ratio | | | |
| Rim intensity | 0.343 | 0.371 | 0.399 |

The result showed that setting the radiation angle ratio to at least 1.35 results in Rim intensity of approximately 0.4.

The upper limit of the radiation angle ratio is of course determined to an appropriate value with which the power becomes high enough to carry out for recording of DVD. The following is the upper limit of the radiation angle ratio determined according to the examination of capability of 4-speed DVD recording.

If assume that recording at a given speed requires light of 8 mW when the DVD objective lens has an NA=0.63, the light intensity required for recording at a speed of 4-times faster is calculated as 8×√4=16.0 mW. That is, 4-speed DVD recording becomes possible when an OL emission intensity of DVD laser light becomes 16.0 mW or greater.

Accordingly, if the intensity of short wavelength laser for DVD is set to 100 mW, and the transmittance of the optical system is set to 0.6, the coupling efficiency is required to be 0.267 or greater to obtain the OL emission intensity of 160 mW or greater. Further, the radiation angle θ∥ of DVD needs to be 16.5° or lower.

Therefore, to perform 4-speed recording, the ratio of the radiation angle θ∥ of DVD laser to the radiation angle θ∥ of CD laser is required to be 2.1 (=16.5°/7.7). Accordingly, the upper limit of radiation angle ratio is 2.1.

In other words, to carry out n-speed DVD recording, a minimum required coupling efficiency is found as follows: a×√n/w/t, where a expresses light intensity required for DVD recording at a given speed, t expresses optical transmittance, and w expresses radiation intensity of short wavelength laser for DVD.

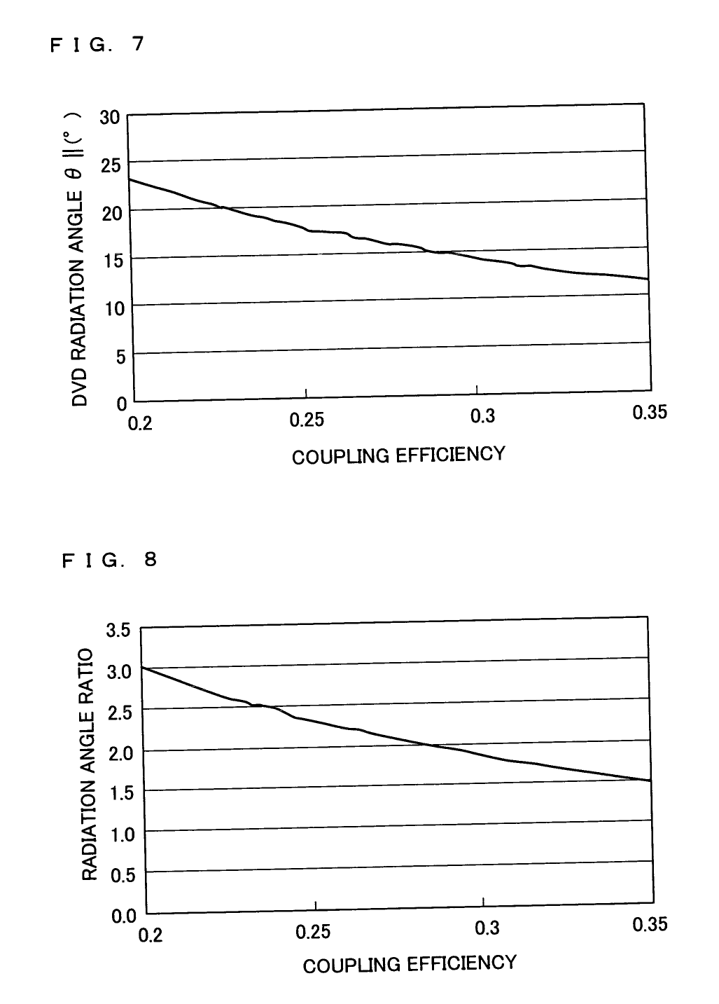

Since the DVD laser radiation angle θ∥ for ensuring this coupling efficiency is uniquely determined based on the relationship between the coupling efficiency and the radiation angle θ∥ shown in FIG. 7, the upper limit of the ratio of the radiation angle θ∥ for DVD laser to the radiation angle θ∥ for CD laser may be appropriately determined.

In FIG. 8, the vertical axis denotes radiation angle ratios, which are found by dividing the respective values of the vertical axis in FIG. 7 by CD laser radiation angle θ∥ (=7.7°). As described, a minimum required coupling efficiency to carry out n-speed DVD recording is found as: a×√n/w/t. Therefore, the upper limit of radiation angle ratio can be appropriately found according to this calculation result.

Similarly, in the case of using a DVD objective lens 0.65 in NA, the radiation angle θ∥ for DVD laser is required to be 17.8 or lower to carry out 4-speed DVD recording. Therefore, the upper limit of the ratio of the radiation angle θ∥ of DVD to the radiation angle θ∥ for CD laser is required to be 2.3 (=17.8°/7.7). In this way, high quality DVD reproduction becomes possible even with a structure using an objective lens capable of information recording into DVD. In other words, information recording into DVD and high quality DVD reproduction can be achieved at the same time.

[2. First Structure Example of Optical Pickup Device]

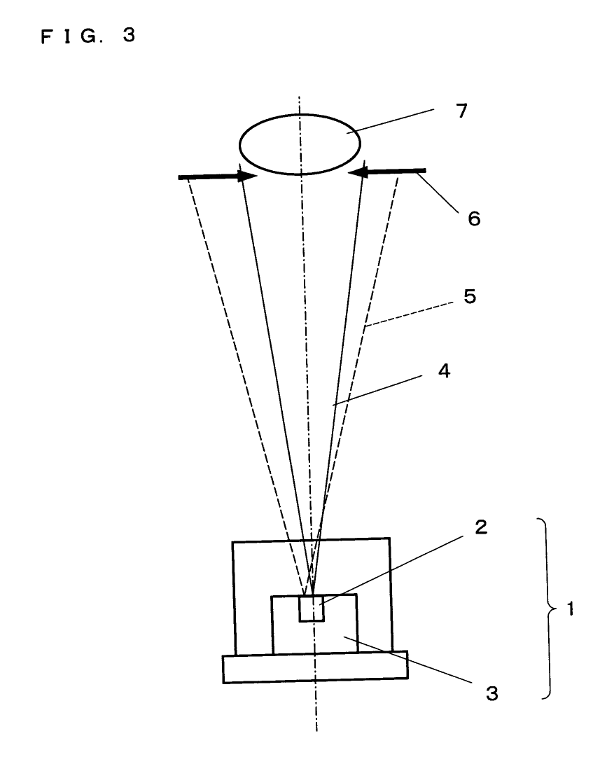

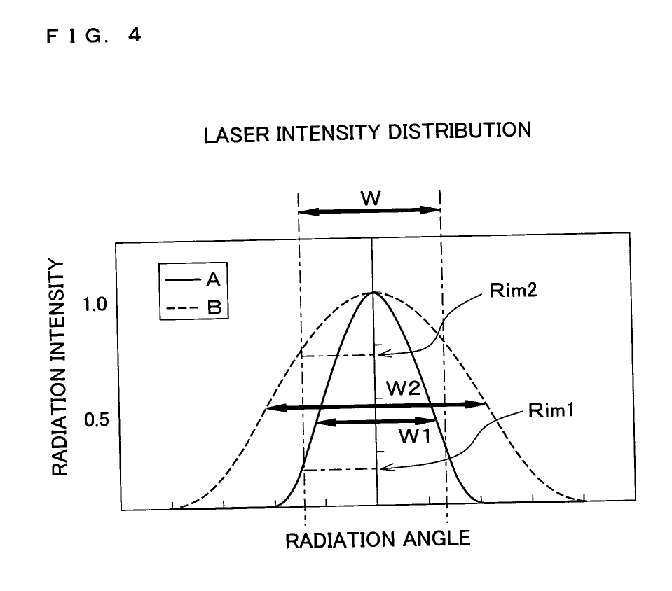

FIG. 3 shows a part of an optical system in an optical pickup device including the laser oscillation device 1 according to the present embodiment. As shown in the figure, the optical pickup device is constituted of the laser oscillation device 1; an objective lens 7; and an opening 6. The laser beam 4 with a longer wavelength, which is used for recording/reproduction of CD, mostly transmits the opening 6, while the laser beam 5 with a shorter wavelength, which is used for reproduction etc. of DVD, is mostly blocked by the opening 6. FIG. 4 shows the relationship between radiation angle and radiation intensity in the state of FIG. 3 where DVD laser light is blocked by an opening 6. In FIG. 4, the relationship between radiation angle and radiation intensity of CD laser light is denoted by a solid line, and the relationship between radiation angle and radiation intensity of DVD laser light is denoted by a broken line.

Further, in FIG. 4, an effective NA (radiation angle breadth), which depends on the diameter of the opening 6, is denoted by W. As can be seen in the figure, the loss of radiation intensity is smaller in the laser light for CD, while it is greater in the laser light for DVD. Therefore, the laser light for CD ensures high light utilization efficiency.

Further, the Rim intensity (Rim 2) of the DVD laser light is higher than the Rim intensity (Rim 1) of CD laser light. The diameter of laser spot on a DVD may be therefore sufficiently condensed.

As described, high-speed recording into DVD and high quality DVD reproduction signal can be achieved at the same time by setting the radiation angle of long wavelength laser light to be smaller than the radiation angle of short wavelength laser light.

The optical pickup device having the foregoing structure may be applied to a combo drive which carries out both recording and reproduction of CD, but carries out only reproduction for DVD. In this case, high-speed recording into CD and high quality DVD reproduction can be achieved at the same time. However, in the case of combo drive capable of DVD recording, the light spot on the optical disk is required to be further condensed, and therefore the objective lens has to have an NA of 0.63 to 0.65. If the optical pickup device of the foregoing radiation angle setting is used in this combo drive, the greater NA causes a decrease in Rim intensity, and the expected effect of large NA cannot be obtained. The further reduction in diameter of light spot on the optical disk is therefore not possible.

In this view, the condition W1×1.35≦W2 is set in which W1 denotes width of radiation angle at which the radiation intensity with respect to CD laser light becomes half of the maximum value, and W2 denotes a full width at half maximum of DVD laser light. This arrangement is shown in FIG. 4. With this arrangement, the diameter of laser light spot on the DVD disk may be sufficiently condensed, and the Rim intensity becomes high enough to carry out high-quality reproduction. Note that, W1 is identical to the radiation angle width θ1 of the light beam 4 (FIG. 1), and W2 is identical to the radiation angle width θ2 of the light beam 5 (FIG. 1).

[3. Second Structure Example of Optical Pickup Device]

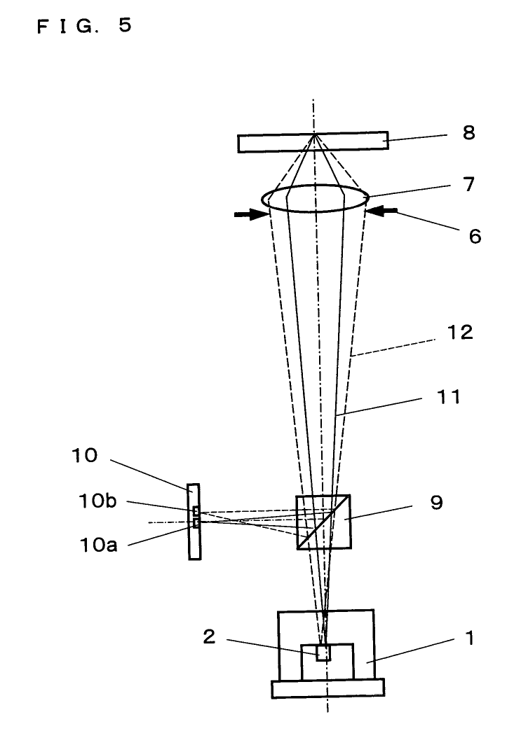

FIG. 5 shows another layout of the optical pickup device including the laser oscillation device 1. This optical pickup device includes the laser oscillation device 1, a beam splitter 9, an objective lens 7, an opening 6 and a photodetector 10. Note that, the objective lens 7 is compatible with two types of laser light of different wavelengths. That is, the objective lens 7 is capable of compensating the spherical aberration which is generated by the thickness difference of the substrate between the CD disk and the DVD disk. Note that, the reference numeral 8 in FIG. 5 denotes either a CD disk or a DVD disk.

The reference numerals 11 and 12 respectively denote a laser beam for CD and a laser beam for DVD oscillated from the laser oscillation device 1. The beams 11 and 12 are incident on different portions of the photodetector 10. Therefore, the photodetector 10 includes a photodetector element (first photodetector) 10a for receiving the beam 11, and a photodetector element (second photodetector) 10b for receiving the beam 12.

In this case, if the incident position of one of the beams 11 and 12 is adjusted by moving the corresponding photodetector element in the photodetector 10, it is not necessary to adjust the light-emitting point or the position of photodetector element of the other beam.

More specifically, as long as the optical system of the optical pickup device is properly constituted as designed, it is not necessary to adjust the position of photodetector. However, since an optical pickup device always involves slight size error or assembly error, it is necessary to adjust the position of the photodetector element in the photodetector.

However, in the laser oscillation device according to the present embodiment, the gap between the two light-emitting points and the gap between the two photodetector elements of the photodetector are each determined with high accuracy of an order of less than 1 μm. In other words, if the light source or the photodetector element of one of the laser beams is off the predetermined position to a certain degree, the light source or the photodetector element of the other laser beam is also off the predetermined position to the same degree.

According to the fact that the gap between the two light sources and the gap between the two photodetector elements are each kept at a certain distance with high accuracy, if the light source of one of the laser beams is adjusted so that the error from the predetermined position is cancelled, the light source and the photodetector element of the other laser beam is also properly positioned substantially as designed.

For example, if the position of the DVD photodetector element is adjusted so as to adjust the light receiving point of DVD laser light in consideration of the position of light-emitting point, the light-emitting point and the position of the photodetector element of the CD laser light are also adjusted.

[4. Third Structure Example of Optical Pickup Device]

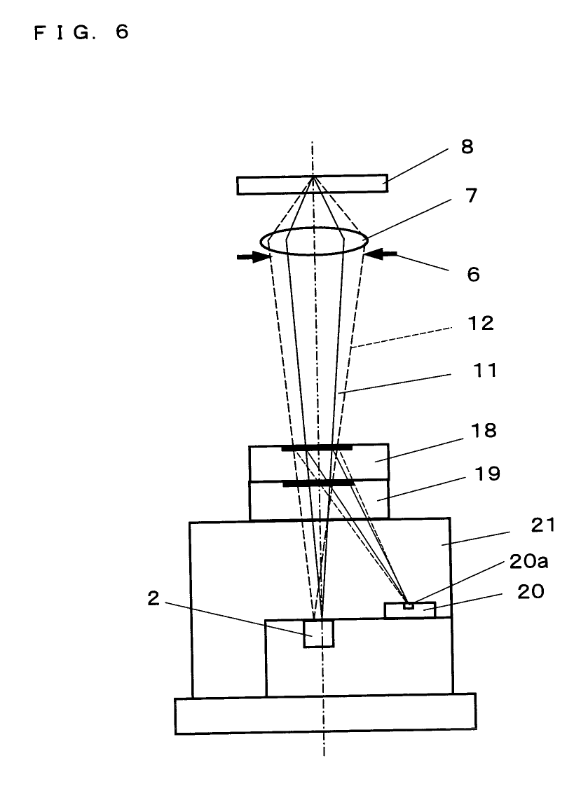

FIG. 6 shows still another structure example of optical pickup device using the light-emitting section 2 of the laser oscillation device 1. This optical pickup device includes a light-emitting section capable of oscillating two kinds of light with different wavelengths; a hologram element (first hologram element) 18 and a hologram element (second hologram elements) 19; a hologram laser unit 21 with a built-in light detector 20; an opening 6; and an objective lens 7. For ease of explanation, materials having the equivalent functions as those shown in FIG. 5 will be given the same reference symbols in FIG. 6, and explanation thereof will be omitted here.

In the hologram laser unit 21, the light beams resulted from diffraction of the beams 11 and 12 at the hologram elements 18 and 19 are incident on the same portion of the photodetector 20. According to this arrangement, the photodetector 20 includes a single photodetector element (third photodetector) 20a which detects both the beam 11 and the beam 12.

The holograms elements 18 and 19 are dedicatedly designed corresponding to the two types of wavelength, respectively. Generally, the hologram element is designed corresponding to the position of light-emitting point, the position of light-condensing point, the location of hologram element, and the position of wavelength. Since the hologram elements 18 and 19 are respectively positioned corresponding to two types of lasers which have different wavelengths and are emitted from different light sources, each of them is dedicatedly designed corresponding to the target wavelength.

Therefore, the beams 11 and 12 can be incident on the same portion of the photodetector 20 by respectively adjusting the holograms 18 and 19 according to the two light beams of different wavelengths. More specifically, the hologram elements 18 and 19 are separately adjusted by being shifted in the x-axis direction and the y-axis direction within the plane vertical to the light axis of the hologram element and in the rotation direction about the light axis so that the beams 11 and 12 are incident on the photodetector element 20a. As a result, the number of photodetector element resulted form the division of the photodetector 20 id reduced, and the structure of the hologram laser unit 21 is simplified. Note that, in the present embodiment, the light emitting section 2 capable of emitting the two types of light with different wavelengths may be constituted as a monolithic type which emits two types of light with different wavelengths from a single laser chip, or as a hybrid type which emits two types of light with different wavelengths from two laser chips.

As has been described, the light-emitting section 2 of the laser oscillation element according to the present embodiment emits first semiconductor laser and second semiconductor laser shorter in wavelength than the first semiconductor laser, a radiation angle width θ2 of the second semiconductor laser being at least 1.3 times a radiation angle width θ1 of the first semiconductor laser, said radiation angle width being defined as a width of an angle created by two straight lines, which extend respectively from a laser-emitting point to two points where a radiation intensity of laser becomes half of an intensity of the center of laser, which points reside on the line of intersection between a plane parallel to a light-emitting plane of the first or the second semiconductor laser and a plane parallel to a pn junction plane.

The inventors of the present invention have carried out an intensive study, and found that the Rim intensity of CD objective lens and the Rim intensity of DVD objective lens can be defined by a ratio (radiation angle ratio, hereinafter) of the radiation angle width of the second semiconductor laser to the radiation angle width of the first semiconductor laser. The inventors further confirmed with an experiment that the radiation angle ratio of at least 1.3 ensures a Rim intensity enabling high-speed CD recording and high-quality DVD reproduction at the same time. Therefore, by being mounted to an optical pickup device, the laser oscillation device 1 including the light-emitting section 2 of the present embodiment realizes high-speed CD recording and high-quality DVD reproduction at the same time.

Said radiation angle width of the second semiconductor laser is preferably at least 1.35 times a radiation angle width of the first semiconductor laser. The inventors measured the Rim intensity of the DVD objective lens, which has a large NA to be capable of information recording, with respect to plural values of radiation angle ratio. Through this measurement, the inventors have found that the radiation angle ratio of at least 1.35 ensures a Rim intensity sufficient for high-quality DVD reproduction.

With the radiation angle ratio of at least 1.35, it becomes possible to realize both recording and high-quality reproduction of DVD even in an optical pickup device including a DVD objective lens capable of information recording, which has a large NA.

An optical pickup device according to the present embodiment comprises the light-emitting section 2 with the foregoing structure; the photodetector element 10a for detecting reflection light of the CD laser light by the optical disk 8; and the photodetector element 10b for detecting reflection light of the DVD laser light by the optical disk 8.

This optical pickup device includes the photodetector elements 10a and 10b for respectively detecting reflection light of the CD laser light and the reflection light of the DVD laser light by the optical disk 8. Therefore, the optical path of the reflection light of CD laser and the optical path of the reflection light of DVD laser can be individually adjusted by changing the positions of respective photodetector elements. This enlarges the range of flexibility in designing the optical pickup device.

The optical pickup device according to the present embodiment may comprise the light-emitting section 2 with the foregoing structure; and the photodetector element 20a for detecting the reflection light of the CD laser light by the optical disk 8 and the reflection light of the DVD laser light by the optical disk 8. With this arrangement, the reflection light of the CD laser light and the reflection light of the DVD laser light are both detected by a single common photodetector element 20a. Therefore the number of components of the optical pickup device is reduced. This allows the constitution of the optical pickup device to be reduced in size. With such a compact optical pickup device, it is possible to realize a smaller recording/reproduction device compatible with CD and DVD.

The optical pickup device may further comprise a hologram element 18 for diffracting the reflection light of the CD laser light by an optical disk 8 so that the reflection light is guided to the photodetector 20a; and a hologram element 19 for diffracting the reflection light of the DVD laser light by an optical disk 8 so that the reflection light is guided to the photodetector 20a; and a hologram laser unit 21 in which the light-emitting section 2, the photodetector element 20a, the hologram element 18 and the hologram element 19 are integrated.

In this structure, the all members constituting the optical pickup device are combined, and the constitution of the optical pickup device can be further reduced in size. With such a compact optical pickup device, it is possible to realize a smaller recording/reproduction device compatible with CD and DVD.

As described, the laser oscillation element according to the present invention emits first semiconductor laser and second semiconductor laser shorter in wavelength than the first semiconductor laser, a radiation angle width of the second semiconductor laser being at least 1.3 times a radiation angle width of the first semiconductor laser, said radiation angle width being defined as a width of an angle created by two straight lines, which extend respectively from a laser-emitting point to two points where a radiation intensity of laser becomes half of an intensity of the center of laser, which points reside on the line of intersection between a plane parallel to a light-emitting plane of the first or the second semiconductor laser and a plane parallel to a pn junction plane.

The radiation angle ratio is set to at least 1.3 in the laser oscillation element with the foregoing structure; therefore, by being mounted to an optical pickup device, the laser oscillation element of the present invention realizes high-speed CD recording and high-quality DVD reproduction at the same time.

The radiation angle width of the second semiconductor laser is preferably at least 1.35 times a radiation angle width of the first semiconductor laser.

An optical pickup device capable of information recording into DVD generally uses an objective lens with a larger NA than that of the objective lens used in the optical pickup device incapable of DVD information recording. For example, the numerical aperture of the reproduction-only DVD objective lens is 0.6, and the numerical aperture of the information recording DVD objective lens is 0.63 to 0.65.

When the first and the second semiconductor lasers are oscillated with the radiation angle ratio of at least 1.3 with respect to an objective lens having such a large NA, the Rim intensity sufficient for high-quality DVD reproduction may not be obtained.

In view of this problem, the inventors measured the Rim intensity of the DVD objective lens, which has a large NA to be capable of information recording, with respect to plural values of radiation angle ratio. Through this measurement, the inventors have found that the radiation angle ratio of at least 1.35 ensures a Rim intensity sufficient for high-quality DVD reproduction.

With the radiation angle ratio of at least 1.35, it becomes possible to realize both recording and high-quality reproduction of DVD even in an optical pickup device including a DVD objective lens capable of information recording, which has a large NA.

The lower limit of the ratio of the radiation angle of the second semiconductor laser to the radiation angle of the first semiconductor laser is preferably determined to an appropriate value with which the Rim intensity required for DVD reproduction by the second semiconductor laser is obtained. The optical pickup device of the present invention may comprises the laser oscillation element with the foregoing structure; a first photodetector for detecting reflection light of the first semiconductor laser by an optical disk; and a second photodetector for detecting reflection light of the second semiconductor laser by an optical disk.

With this arrangement, the optical pickup device includes the first and second semiconductor lasers which respectively detect the reflection light of the first semiconductor laser by an optical disk and the reflection light of the second semiconductor laser by an optical disk. Therefore, the optical path of the reflection light of CD laser and the optical path of the reflection light of DVD laser can be individually adjusted by changing the positions of respective photodetector elements. This enlarges the range of flexibility in designing the optical pickup device.

Further, the optical pickup device according to the present invention may comprise the laser oscillation element having the foregoing structure; a third photodetector for detecting reflection light of the first semiconductor laser by an optical disk and reflection light of the second semiconductor laser by an optical disk.

With this arrangement, the reflection light of the CD laser light and the reflection light of the DVD laser light are both detected by a single common third photodetector element. Therefore the number of components of the optical pickup device is reduced. This allows the constitution of the optical pickup device to be reduced in size. With such a compact optical pickup device, it is possible to realize a smaller recording/reproduction device compatible with CD and DVD. The optical pickup device of the present invention may further comprises a first hologram element for diffracting the reflection light of the first semiconductor laser by an optical disk so that the reflection light is guided to the third photodetector; a second hologram element for diffracting the reflection light of the second semiconductor laser by an optical disk so that the reflection light is guided to the third photodetector; and a laser hologram unit in which the laser oscillation element, the third photodetector, the first hologram element and the second hologram element are integrated.

In this structure, the all members constituting the optical pickup device are combined, and the constitution of the optical pickup device can be further reduced in size. With such a compact optical pickup device, it is possible to realize a smaller recording/reproduction device compatible with CD and DVD.

The laser oscillation device of the present invention may be a semiconductor laser oscillation device capable of emitting plural types of laser light of different wavelengths wherein a radiation angle width of short oscillation-wavelength laser is at least 1.3 times a radiation angle width of a long oscillation-wavelength laser.

The foregoing laser oscillation device with the foregoing arrangement may be arranged so that the short oscillation-wavelength laser and the long oscillation-wavelength laser are both outputted with enough power to carry out information recording into an optical disk. Otherwise, it may be arranged so that only the long oscillation-wavelength laser is outputted with enough power to carry out information recording into an optical disk.

Further, the optical pickup device of the present invention may comprise a semiconductor laser oscillation device capable of emitting plural laser beams with different wavelengths; a collective lens for condensing the laser radiation onto an optical disk; and photo-detecting sections for detecting reflection light from the optical disk, wherein the photo-detecting sections are differently structured to correspond to the target wavelength.

Further, the optical pickup device of the present invention may comprise a semiconductor laser oscillation device capable of emitting plural laser beams with different wavelengths; a collective lens for condensing the laser radiation onto an optical disk; and a hologram element, provided between the semiconductor laser and the collective lens, for allowing the laser beam to pass through and diffracting the reflection light from an optical disk so that the reflection light is guided to the photodetector; and a photodetector for detecting the reflection light from the optical disk. In this optical pickup device, the semiconductor laser, the hologram element and the photodetector are integrated.

This optical pickup device may include a single common photo-detecting section capable of detecting the two wavelengths, instead of the plural photo-detecting sections differently structured to correspond to the target wavelength.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention offers an effect of ensuring CD high-speed recording and DVD high-quality reproduction at the same time. With this effect the present invention is suitable for a combo drive for performing recording/reproduction of CD, DVD etc.

1. A laser oscillation element for emitting first semiconductor laser and second semiconductor laser shorter in wavelength than the first semiconductor laser, a radiation angle width of the second semiconductor laser being at least 1.3 times a radiation angle width of the first semiconductor laser, said radiation angle width being defined as a width of an angle created by two straight lines, which extend respectively from a laser-emitting point to two points where a radiation intensity of laser becomes half of an intensity of the center of laser, which points reside on the line of intersection between a plane parallel to a light-emitting plane of the first or the second semiconductor laser and a plane parallel to a pn junction plane.

2. The laser oscillation element as set forth in claim 1, wherein said radiation angle width of the second semiconductor laser being at least 1.35 times a radiation angle width of the first semiconductor laser.

3. The laser oscillation element as set forth in claim 1, wherein a lower limit of a ratio of said radiation angle of the second semiconductor laser to said radiation angle of the first semiconductor laser is determined to an appropriate value with which a required Rim intensity for DVD recording/reproducing by the second semiconductor laser is obtained.

4. An optical pickup device, comprising:
the laser oscillation element as set forth in claim 1;
a first photodetector for detecting reflection light of the first semiconductor laser by an optical disk; and
a second photodetector for detecting reflection light of the second semiconductor laser by an optical disk.

5. An optical pickup device, comprising:
a laser oscillation element as set forth in claim 1;
a third photodetector for detecting reflection light of the first semiconductor laser by an optical disk and reflection light of the second semiconductor laser by an optical disk.

6. The optical pickup device as set forth in claim 5, further comprising:
a first hologram element for diffracting the reflection light of the first semiconductor laser by an optical disk so that the reflection light is guided to the third photodetector;
a second hologram element for diffracting the reflection light of the second semiconductor laser by an optical disk so that the reflection light is guided to the third photodetector; and
a hologram laser unit in which the laser oscillation element, the third photodetector, the first hologram element and the second hologram element are integrated.
